(19) United States
(12) Patent Application Publication
(10) Pub. No.: US 2020/0378218 A1
(43) Pub. Date: Dec. 3, 2020

(54) ENCLOSURE DEVICE FOR REMOVABLE AND RECONFIGURABLE RACKS SUPPORTING ARRAYS OF CONDUITS

(71) Applicant: Nelsen Technologies Inc., Leduc, AB (CA)

(72) Inventors: Blair Nelsen, Leduc (CA); James Chisholm, Leduc (CA)

(73) Assignee: Nelsen Technologies Inc., Leduc, AB (CA)

(21) Appl. No.: 16/882,285

(22) Filed: May 22, 2020

(30) Foreign Application Priority Data
May 28, 2019 (CA) 3044577

(51) Int. Cl. E21B 41/00; H02G 3/04

(52) U.S. Cl. CPC E21B 41/00; H02G 3/0456

(57) ABSTRACT

An enclosure device for protection of drilling rig service utilities. The device includes a frame substantially covered by a plurality of removable or hinged panels to provide access to one or more racks for receiving and holding one or more arrays of conduits. The frame is configured to support one or more removable and reconfigurable racks for supporting the arrays of conduits within the enclosure with ends of the conduits extending outside of the enclosure device.

### CROSS-REFERENCE TO RELATED APPLICATION

This application claims priority to Canadian Patent Application No. 3,044,577, filed May 28, 2019, which is hereby incorporated herein by reference in its entirety.

### FIELD

The technology described herein relates to servicing drilling rigs and more specifically to enclosures for protecting conduits and cables which provide utility services to drilling rigs.

### BACKGROUND

Multi-well pad drilling is the practice of drilling multiple wellbores from a single surface location. Prior to development of pad drilling, an operator would drill a single well, disassemble the drilling rig, move it to a new location, and then repeat the process. Through multi-pad drilling, several wells can be drilled at a single, compact piece of land. Doing so saves time and resources that would be spent packing and moving the rig and preparing a new drilling site. Multi-pad drilling also makes a smaller impact on the surface area.

Drilling rigs support a vast array of equipment requiring service with utilities such as electrical cables, fuel lines, lubricant lines, hydraulic fluid lines, drilling fluid lines, air lines, steam lines, and condensate return lines. In conventional drilling rig utility arrangements, these utilities are grouped together and housed in modular enclosures known as “umbilical systems” or “suitcases.” These enclosures are used in multi-well pad well drilling operations where the drilling unit moves around the well sites from hole to hole while the main support module of the multi-well pad remains stationary. The utility lines and cables are routed through the suitcases from the support module to the drilling unit in order to protect and insulate the utility lines and cables from harsh conditions at the well site. In a typical operation, 5 to 6 utility enclosures are used in supporting the drilling operation.

Examples of drilling rig utility enclosures are described in U.S. Pat. Nos. 5,407,302 and 6,962,030, each of which is incorporated herein by reference in its entirety. Suitcases/utility enclosures are also briefly described on the internet site of CRG Boiler Systems (Odessa, Tex., USA) (www.crgboilers.com/drilling-rig-utility-suitcase.html).

As multi-well pad drilling operations increase, there is a concomitant need for improvements in drilling rig utility enclosures.

### SUMMARY

In accordance with one embodiment, there is provided an enclosure device of the type known in the art as a “suitcase” or “umbilical device” for protection of drilling rig service utilities. The device includes a frame substantially covered by a plurality of removable or hinged panels to provide access to one or more racks for receiving and holding one or more arrays of conduits. The frame is configured to support one or more removable and reconfigurable racks for supporting the arrays of conduits within the enclosure with ends of the conduits extending outside of the enclosure device.

The plurality of removable or hinged panels may include at least one hinged or removable top panel to provide access to an interior rack.

The plurality of removable or hinged panels may include at least one hinged or removable side panel to provide access to at least one lateral rack.

The frame may include a plurality of sets of inner frame members, wherein at least some of the sets inner frame members are connected to support components used to form the one or more removable and reconfigurable racks.

The sets of inner frame members may each include a pair of opposed vertical supports and wherein at least some of the support components used to form the one or more removable and reconfigurable racks includes sets of spacers connected medially between the vertical supports to form an interior rack.

Each set of spacers may include individual spacers defined by either upper or lower cut out portions matched to adjacent spacers to form openings for holding the conduits. The lower cut out portions may have lower conduit clamp halves connected thereto. The enclosure device may further include separate upper conduit clamp halves for connecting to the lower conduit clamp halves following placement of conduits on the lower conduit clamp halves.

At least some of the components used to form the one or more removable and reconfigurable racks may include a lateral rack member connected laterally to at least some of the vertical supports.

The enclosure device may include six sets of inner frame members, wherein two of the six sets of inner frame members are located at the ends of the enclosure device and are each provided with spacer sets which form end walls of the enclosure device.

The vertical supports of the two sets of inner frame members located at the ends of the enclosure device may have lateral rack members connected thereto.

The lateral rack members of one side of the enclosure device may be configured to support a first outer array of conduits having conduits of two different diameters and the lateral rack members of the other side of the enclosure device may be configured to support a second array of conduits having conduits of the same diameter.

The first outer array of conduits may include three conduits having an inner diameter of about 2 inches (about 5.1 cm) and two conduits having an inner diameter of about 1.5 inches (about 3.8 cm). The second outer array of conduits may include ten conduits having an inner diameter of about 1 inch (about 2.5 cm).

The sets of spacers may be configured to support six conduits having inner diameters of at least about 3 inches (about 7.6 cm) in a staggered arrangement. The six conduits may include four conduits having an inner diameter of about 3 inches (about 7.6 cm), one conduit having a diameter of about 4 inches (about 10.2 cm) to about 5 inches (about 12.7 cm) and one conduit having an inner diameter of about 6 inches (about 15.2 cm) to about 8 inches (about 20.3 inches).

In one embodiment, the enclosure device has a length of about 40 feet (about 12.2 m) and a width of about 3 feet, 8 inches (about 111 cm).

The enclosure device may further include one or more cable support trays supported by upper frame members of the frame.

The enclosure device may further include a hitch connected to each end of the enclosure device for coupling to a towing vehicle.

The enclosure device may further include a pair of forklift sockets formed in frame base members of the frame.

The enclosure device may further include a pair of runners connected to the undersides of each of the frame base members.

### BRIEF DESCRIPTION OF THE DRAWINGS

Various objects, features and advantages of the technology will be apparent from the following description of particular embodiments, as illustrated in the accompanying drawings. The drawings are not necessarily to scale. Instead, emphasis is placed upon illustrating the principles of various embodiments. Similar reference numerals indicate similar components. A number of possible alternative features are introduced during the course of this description. It is to be understood that, according to the knowledge and judgment of persons skilled in the art, such alternative features may be substituted in various combinations to provide different embodiments.

FIG. 1 is a perspective view of one embodiment of a utility enclosure 10 showing closed top panels 22 and closed side panels 24. The utility enclosure 10 holds three conduit arrays including an inner conduit array A-1 and outer conduit arrays A-2 (left) and A-3 (right).

FIG. 2 is a side elevation truncated view of the utility enclosure 10 in the same arrangement as FIG. 1.

FIG. 3 is a perspective view of the utility enclosure 10 in a configuration prior to installation of conduit arrays A-1, A-2 and A-3 and showing open top panels 22 with the side panels 24 removed.

FIG. 4 is a perspective view of the utility enclosure 10 showing open top panels 22 with the side panels 24 removed. The inner conduit array A-1 and outer conduit arrays A-2 and A-3 are partially assembled.

FIG. 5 is a perspective view of the utility enclosure 10 showing open top panels 22 with the side panels 24 removed. The inner conduit array A-1 and outer conduit arrays A-2 and A-3 are completely assembled.

FIG. 6 is a perspective view of the utility enclosure 10 showing open top panels 22 with the side panels 24 removed. The inner conduit array A-1 and outer conduit arrays A-2 and A-3 are completely assembled and upper cable trays 29a and 29b are installed.

FIG. 7A is a front elevation view of the utility enclosure 10 in a similar configuration as shown in FIG. 3, showing open top panels 22 with the side panels 24 removed. The inner conduit array A-1 and outer conduit arrays A-2 and A-3 are absent.

FIG. 7B is a front elevation view of the utility enclosure 10 similar to that of FIG. 7A, following installation of a spacer set 28 for forming a rack to support the inner conduit array A-1 which is absent in this view.

FIG. 7C is a view similar to that of FIG. 7B, showing the inner conduit array A-1 supported in the utility enclosure 10 by the spacer set 28. Outer conduit arrays A-2 and A-3 are also installed and covered by side panels 24.

FIG. 7D is the same view and arrangement as FIG. 7C with labelling of individual conduits included.

FIG. 8 is an assembly scheme in five parts showing how the front spacer set is formed using individual spacers 32, and 35-39 to support the inner conduit array A-1.

FIG. 9A is a partial side elevation view of utility enclosure 10 provided for the purpose of indicating a cross section of subsequent FIG. 9B.

FIG. 9B is a cross section taken alone line 9B-9B of FIG. 9A, to illustrate conduit clamps associated with the conduits of the inner conduit array A-1.

FIG. 9C is a perspective view of the cross section of FIG. 9B.

FIG. 10 is an alternative utility enclosure embodiment 100 which is provided with four hinged side panels 124.

### DETAILED DESCRIPTION

### Introduction and Rationale

Multi-well pad operations are relatively new in well drilling and there are several aspects of multi-well pad operations that can benefit from technical improvements. Conventional utility enclosures used at multi-well pad sites are steel boxes which are typically constructed onsite in an ad hoc manner by welding with little consideration given to their functionality other than simply covering the conduits and cables contained therein. The present inventors have recognized that conventional utility enclosures have not received adequate attention from a construction perspective after learning of significant problems arising from leaking conduits inside a utility enclosure which could not be opened easily due to multiple welded portions. Such problems can significantly hinder drilling operations. The inventors are aware of one case where a conduit carrying hydraulic fluid inside a sealed and welded utility enclosure leaked significantly and could not be addressed in a timely manner, resulting in loss of well control. Solutions to this and other problems are provided by the embodiments described herein. These embodiments provide features which allow conduits to be easily accessed, inspected and replaced within utility enclosure and which provide the option to customize the numbers and configurations of conduits which are protected by the utility enclosure.

### Example Embodiments of a Drilling Rig Utility Enclosure

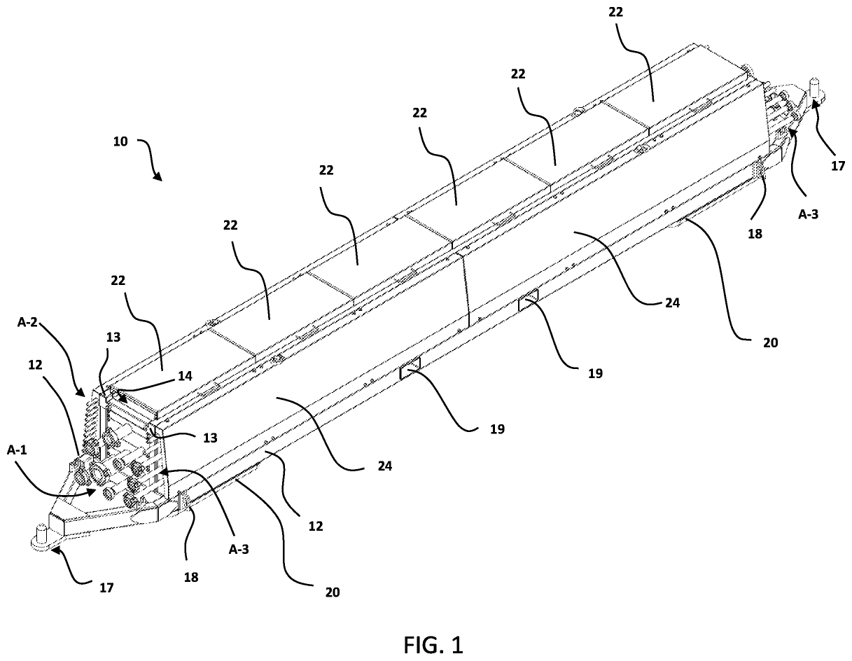

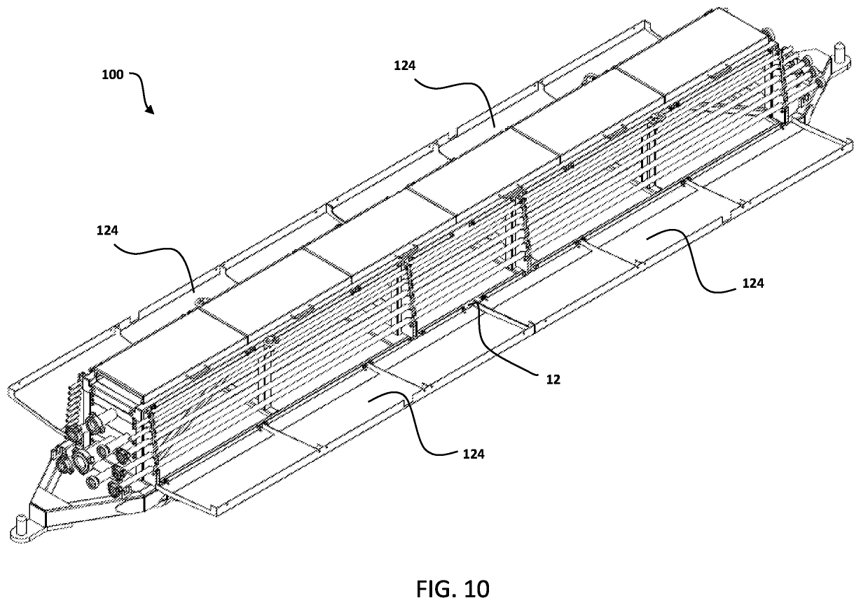

In FIGS. 1 to 9, there are shown various views and portions of a main example embodiment of a utility enclosure 10 for supporting equipment associated with the functions of a drilling rig. An alternative embodiment 100 is shown in FIG. 10 and will be briefly described following a description of the main embodiment 10. The view of FIG. 1 shows the utility enclosure 10 in a closed and functional arrangement where three separate conduit arrays A-1 (inner array), A-2 (left side array) and A-3 (right side array) are contained within the enclosure 10 with free ends of conduits emerging from the front and back ends of the enclosure 10 (in this view, only conduit array A-3 is visible from the back end of the enclosure 10). During drilling operations, these conduit free ends would be connected to other conduits leading to the drilling rig or to another utility enclosure in a series of such enclosures which may be similar in construction to the present embodiment 10, or to differently constructed enclosures or to any other equipment required to provide the service function of each individual conduit, such as pumps and related equipment, for example. The enclosure 10 thus retains the conduits in an enclosed space to protect them from damage from the elements and incidental impacts which may occur at the drill site during drilling rig operations.

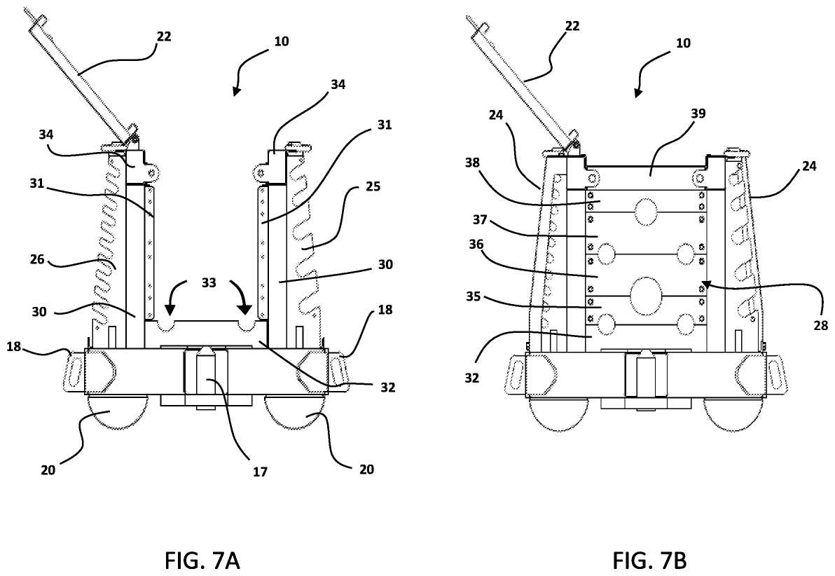

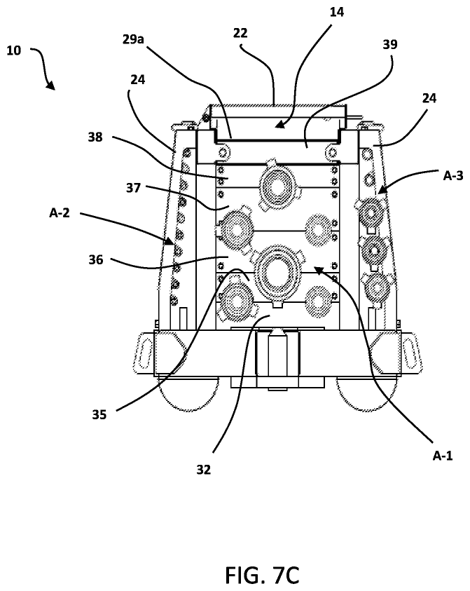

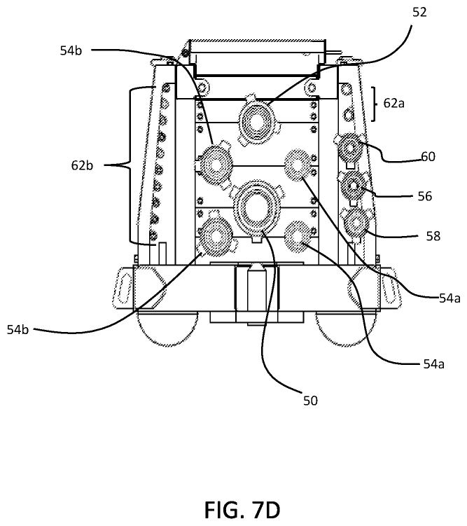

In the present example embodiment, the conduits are in the form of piping of different sizes, as illustrated in a front elevation view shown in FIG. 7D. The single conduit with the largest diameter is located in the lower center of the inner conduit array A-1 and may have an inner diameter of about 6 inches (about 15.2 cm) to about 8 inches (about 20.3 cm). This piping is the drilling fluid return line 50 which is used as a suction line to return drilling fluid back to the pumping area. The single conduit with the second largest diameter is located in the upper center of the inner conduit array A-1 may have an inner diameter of about 4 inches (about 10.2 cm) to about 5 inches (about 12.7 cm). This conduit is the main drilling fluid line 52 for pumping drilling fluid downhole. The inner conduit array A-1 also includes four water lines 54a, 54b of an inner diameter of about 3 inches (about 7.6 cm), each located closer to the sides of the enclosure 10. Two of these lines are main water lines 54a and the other two lines are water return lines 54b. These water lines are used for general washing and for servicing the scalping tank of the drilling rig. The outer conduit array A-3 on the right side has five lines including three lines of an inner diameter of about 2 inches (about 5 cm): a main steam line 56, a return steam line 58, and an air line 60, as well as two hydraulic lines 62a having an inner diameter of about 1.5 inches (about 3.8 cm). The steam lines 56, 58 are used to provide heating and the air line 60 is used for various applications on the rig which require pressurized air.

The outer conduit array A-2 on the left side has a total of ten hydraulic lines 62b all with an inner diameter of about 1 inch (about 2.5 cm). These ten hydraulic lines 62b of conduit A-2 and the two other hydraulic lines 62a of conduit array A-3 are used for transfer of hydraulic fluid for various applications on the drilling rig including control of blowout preventers, for example.

This particular arrangement is advantageous because the conduit ends are in a staggered array in order to provide suitable spacing between them. It is seen in FIG. 7D that some of the ends of the conduits are provided with hammer union connectors having three equi-spaced lugs. The inventors have recognized that it is particularly useful to provide appropriate spacing between conduit ends that have such hammer union connectors because the lugs of connectors on adjacent conduits can interfere with each other, causing problems in disengaging existing connections. In one useful arrangement, conduits of different lengths are used in the conduit arrays such that their free ends emerging from the enclosure 10 are offset relative to each other to prevent such interference during the process of making outside connections to the conduits of the arrays.

While specific configurations of conduits are described for this particular utility enclosure embodiment 10, it is to be understood that a number of variations are possible in alternative embodiments, wherein fewer or additional conduits of various diameters may be housed by the enclosure, as dictated by drilling rig utility service requirements. Such alternative configurations of conduits can be accommodated by the general structure of the enclosure if suitable modifications are made to the spacer sets and lateral rack members which hold the conduits in place, as will be described in more detail hereinbelow.

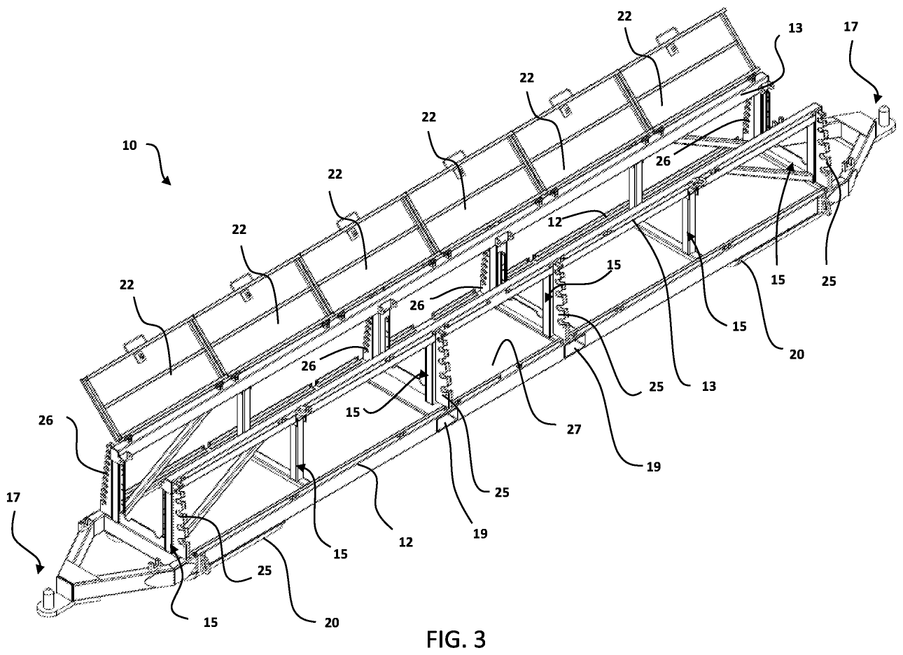

Turning now to FIG. 3, it can be seen that the enclosure 10 includes a frame formed of a pair of frame base members 12, a pair of opposed upper frame members 13, and six sets of inner frame members 15. This arrangement has been found to provide sufficient structural stability for an embodiment of the utility enclosure 10 having a length of about 40 feet (12.2 m) and a width of about 3 feet, 8 inches (about 111 cm). Among the useful features associated with the frame of the enclosure are hitches 17 located on each end of the frame, two lifting rings 18 located on each side of the frame, each located closer to the ends of the frame, a pair of forklift sockets 19 extending through each of the frame base members 12, which are spaced to accommodate entry of the forks of a standard forklift, and a pair of runners 20 mounted to the underside of each of the frame base members 12. The hitch 17 and runners 20 facilitate movement of the utility enclosure 10 over short distances on the ground at the drilling site using a towing vehicle and the lifting rigs 18 can be used to connect the utility enclosure 10 to a lifter for transfer onto a transport vehicle (not shown). A forklift can be used to transport the enclosure 10 with placement of its forks into the forklift sockets 19, which are located near the center of gravity of the enclosure 10 and placed appropriately such that the mass of the enclosure 10 is properly balanced on the forklift forks when lifted by a forklift. It is to be understood that alternative embodiments will include alternative forms of these features. For example, an alternative embodiment may include wheels instead of runners 20 and/or an alternative coupler arrangement for coupling to a lifter.

The utility enclosure 10 includes six top panels 22 which are hinged to one of the upper frame members 13. Alternative embodiments may include fewer or more top panels which may be removable rather than hinged. If it is desirable to minimize the footprint of equipment associated with the utility enclosure 10, the hinged upper panels 22 are considered advantageous as they remain within the general footprint of the utility enclosure 10. The hinged top panels 22 are closed in FIGS. 1, 2, 7C and 7D and open in FIGS. 3-6, 7A and 7B.

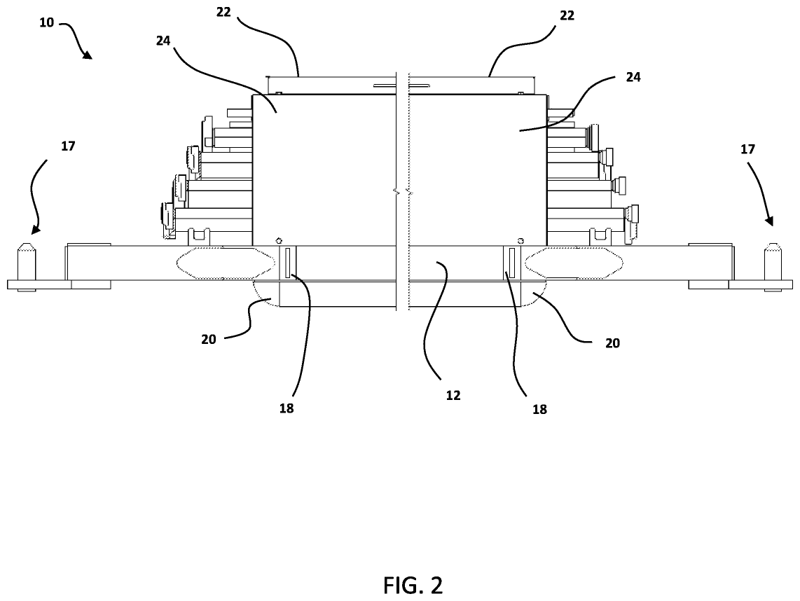

The utility enclosure 10 includes two side panels 24 on each side. Alternative embodiments may include only one side panel on each side, or more than two panels on each side. In this particular embodiment, the side panels 24 are removable instead of being hinged. The advantage to providing removable side panels 24 is that conduits contained within the enclosure 10 can be more easily accessed and inspected from the sides of the enclosure 10 (without being blocked by raised or lowered hinged side panels). In an alternative embodiment, a disengageable panel mechanism such as a hinge system with a sliding and disengaging hinge pin (not shown) may be provided so that the side panels can be retained in place when opened or removed from the utility enclosure 10. The side panels 24 are attached in FIGS. 1 and 2 and removed in FIGS. 3-6.

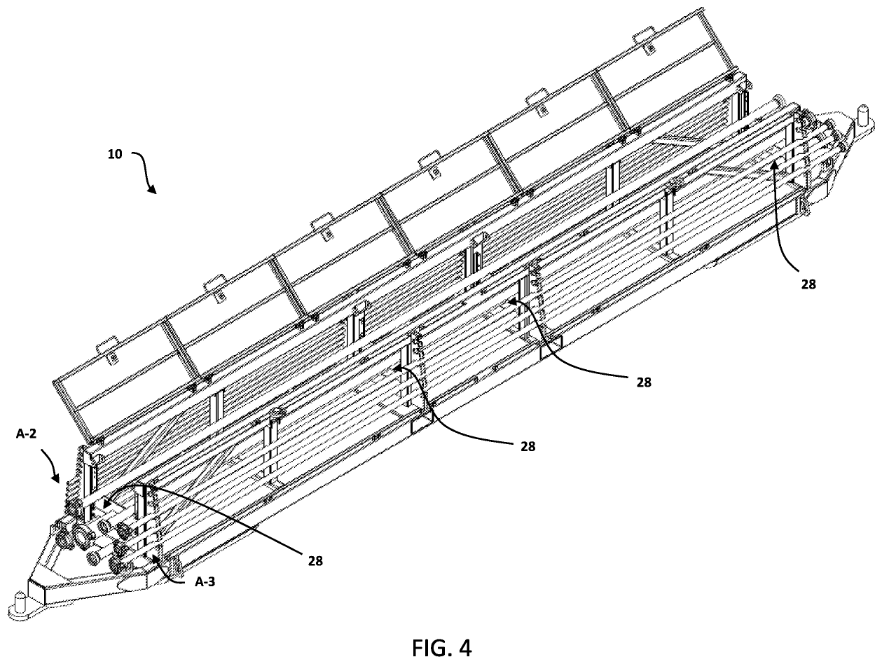

FIG. 4 illustrates partial assembly of four inner conduit spacer sets 28 in order to collectively form a rack for the inner conduit array A-1 which is partially formed in FIG. 4. The individual parts of an inner conduit spacer set 28 will be described and illustrated in more detail in FIGS. 7A to 7C. In addition, the outer conduit arrays A-2 (left) and A-3 (right) are also partially assembled in the lateral racks. Outer conduit array A-3 (right) has three of its five conduits in place in the right side lateral rack formed by the four right lateral rack members 25 and outer conduit array A-2 (left) has five of its ten conduits in place in the left side lateral rack formed by the four left lateral rack members 26.

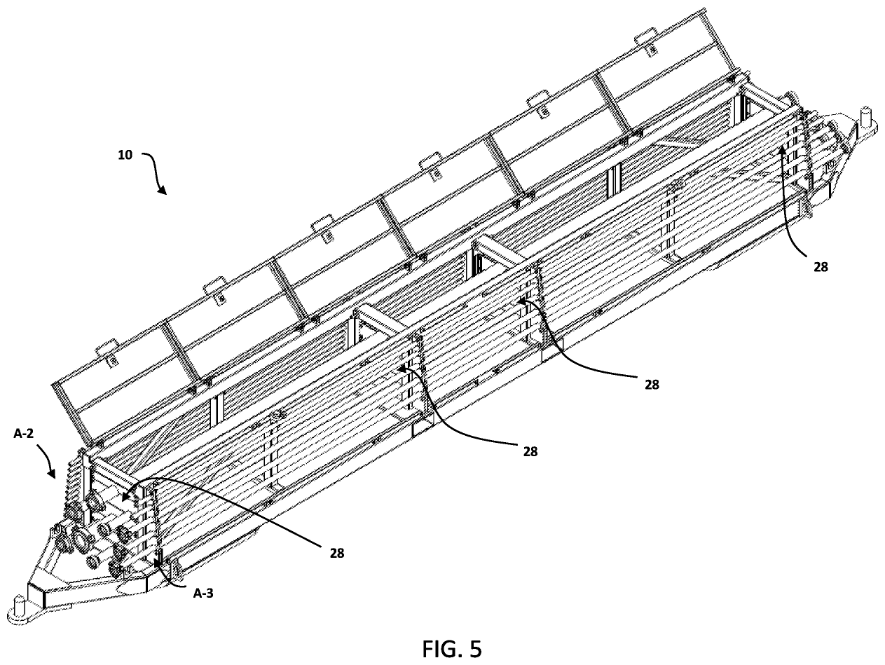

FIG. 5 shows complete assembly of the four inner conduit spacer sets 28, the completely assembled inner conduit array A-1 as well as completely assembled outer conduit arrays A-2 and A3.

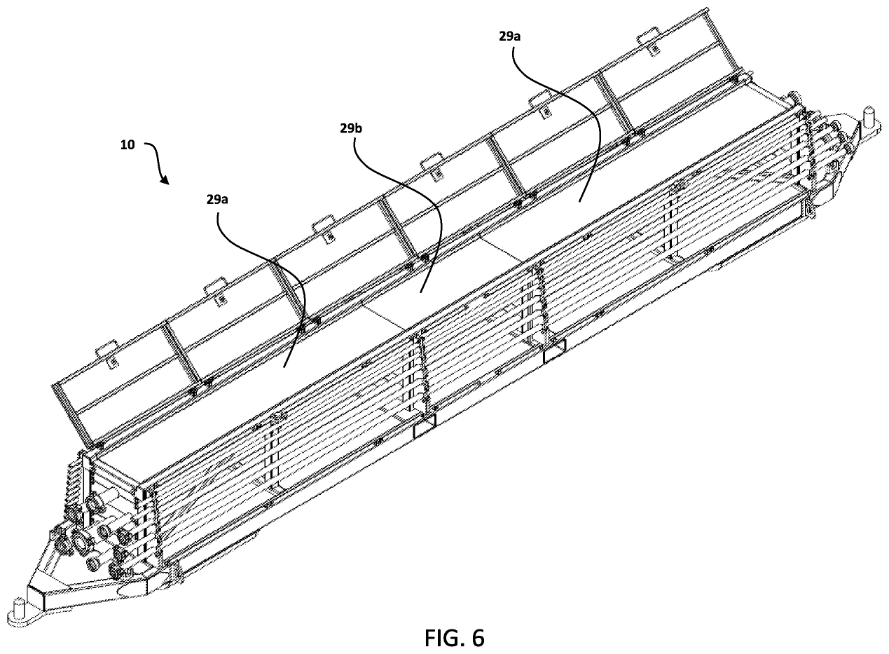

FIG. 6 shows installation of a horizontal cable platform formed by two longer cable trays 29a and one smaller middle cable tray 29b. While not shown in FIG. 6, it is to be understood that cables can be placed on the this cable platform and thereby supported within the enclosure 10, extending outward from both ends between an open space 14 between the closed top panels 22 and the upper surface of the cable platform formed by the two longer cable trays 29a and smaller middle cable tray 29b. Cables emerging from the enclosure via the space 14 will be connected appropriately via joints to form longer cables for connection to electrical equipment servicing the drilling rig.

FIGS. 7A to 7C illustrate features associated with front rack members 25 and 26 and the front conduit spacer set 28. It is to be understood that the remaining rack members 25 and 26 and the remaining conduit spacer sets 28 have substantially identical features in this embodiment to cooperate in forming the inner and lateral racks for the conduit arrays A-1, A-2 and A-3. FIG. 7A shows a front elevation view of enclosure 10 in an arrangement similar to the arrangement of FIG. 3, prior to assembly of conduit spacer sets 28. The top panels 22 are open and the side panels 24 are absent. It can be seen that the each of the sets of inner frame members 15 is formed of a pair of vertical supports 30 each connected to a corresponding upper bracket 34 to form a connection to a corresponding upper frame member 13 (which is hidden from view by the bracket 34). The outer rack members 25 and 26 are connected to the outer edges of the vertical supports 30. A bottom spacer 32 extends between the two vertical supports 30. A pair of radiused cutouts 33 are formed in the upper edge of the bottom spacer 32. The radiused cutouts 33 are provided to hold two lowermost conduits as part of the rack formed by similar radiused cutouts on equivalent bottom spacers 32 of three of the remaining sets of inner frame members 15 (see FIG. 3). Returning to FIG. 7A, it is seen that a spacer bracket 31 is coupled to the inner edge of each of the vertical supports 30 to provide a means for connecting additional spacers to the vertical supports 30. In this embodiment, the spacer brackets 31 are provided with holes for bolts, pins or other means for fastening spacers to the spacer brackets 31.

FIG. 7B shows complete assembly of the inner conduit spacer set 28 within the sets of inner frame members 15 as well as the presence of the side panels 24. It is seen that connection of spacers 35-38 to the spacer bracket 31 results in cutouts of the spacers forming six openings in the spacers for holding the conduits of the inner conduit array A-1 which are not shown in FIG. 7B. A last upper spacer 39 is connected between the two upper brackets 34 which are mounted on the upper frame members 13.

FIG. 7C illustrates a similar front elevation view as FIGS. 7A and 7B in a complete functional arrangement of the inner conduit array A-1. The cable tray 29a is installed and the top panels 22 are closed. FIG. 7D is the same view showing labelling of individual conduits which include lines for drilling fluid 50, 52, steam 56, 58, air 60, water 54a, 54b and hydraulic fluid 62a, 62b which have been described in more detail hereinabove.

While only one set of conduit configurations has been described for this utility enclosure 10 to this point, it is to be understood that the utility enclosure 10 is customizable to provide different arrays of conduits having different diameters. For example, the inner conduit array could include four or fewer large diameter conduits or more than six conduits of smaller diameters. In such cases, the spacers would be altered to include radiused cutouts to accommodate the different diameters in an arrangement which maximizes the spacing between the conduits. In addition, while the racks formed by the rack members include a left lateral rack for holding 10 small diameter conduits and a right lateral rack for holding three larger diameter conduits and two smaller diameter conduits, the rack members are also interchangeable to provide the capability of customizing the racks to hold conduits with different diameters.

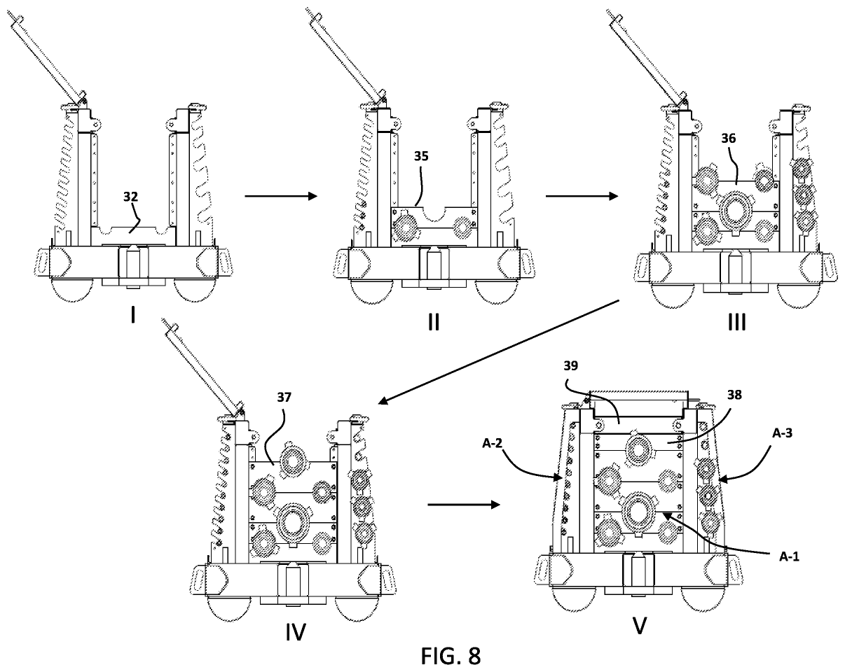

FIG. 8 shows a sequence of front views of the utility enclosure 10 as an inner conduit spacer set 28 and conduit arrays A-1, A-2 and A-3 are assembled with most of the previously introduced reference numerals omitted to preserve clarity. In step I, only the inner frame set is visible. In step II, two conduits have been placed on the cutouts of the bottom spacer 32 and the next spacer 35 which has two lower cutouts matched to the cutouts 33 of spacer 32 has been connected to the spacer brackets 31. In addition, three of the smallest diameter conduits have been placed in the left rack. In step III, the largest central conduit has been placed on the cutout of spacer 35 and spacer 36 has been placed on top of the upper cutout of spacer 35. Two of the smaller conduits of the inner array A-1 have been placed on the upper cutouts of spacer 36. In addition, two more of the smallest conduits have been placed in the left lateral rack and three larger conduits have been placed in the right lateral rack. In Step IV, spacer 37 has been placed on top of spacer 36 and a central conduit has been placed on the upper cutout of spacer 37. In addition, the remaining conduits have been placed on the left and right racks. In step V, the last spacers 38 and 39 has been installed to complete the spacer set 28. The top panels 22 are closed and the side panels 24 are installed.

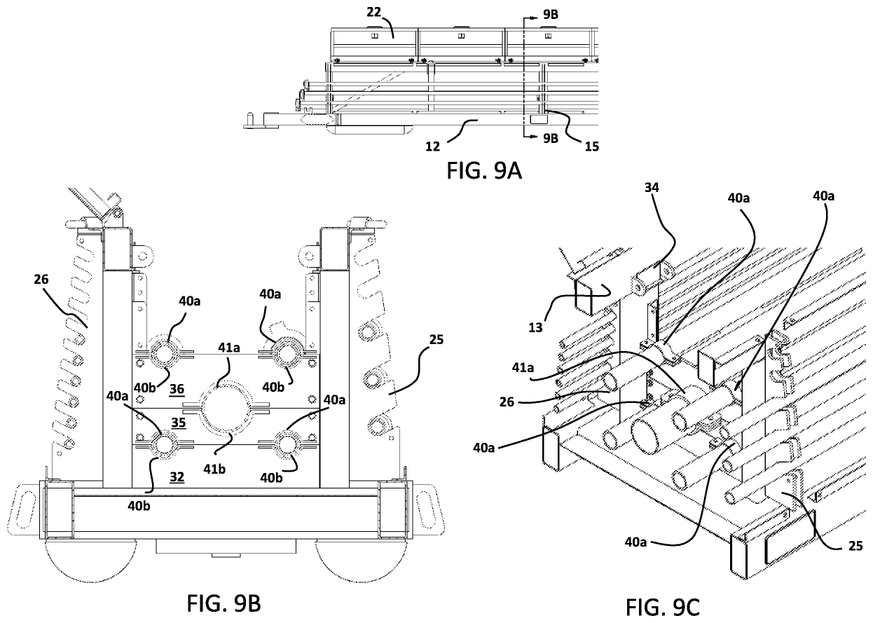

FIG. 9A is a partial side elevation view provided to show a cross section taken along lines 9B-9B which is magnified in FIG. 9B. A perspective view of the same magnified cross section is shown in FIG. 9C. The views of FIGS. 9B and 9C are provided to illustrate clamps formed of upper clamp halves 40a and 41a which are matched with lower clamp halves 40b and 41b to form clamps to stabilize and retain the conduits of the inner conduit array in place on the spacer cutouts, thereby preventing conduits from slipping out of the enclosure 10. While the clamps are shown for a partially assembled inner conduit array A-1, it is to be understood that similar clamps are included for the complete inner conduit array A-1. It can be seen in the perspective view of FIG. 9C that the clamp halves are wider than the width of the spacers. For convenience, the lower clamp halves 40b and 41b may be permanently connected to their corresponding spacers to prevent them from being misplaced when the inner conduit array is being assembled. The upper clamp halves 40a, 41b may be connected to the lower clamp halves 40b, 41b using bolts or other fasteners. The lower clamp halves 40b, 41b provide a larger surface area which facilitates placement of conduits during the assembly process. In some embodiments, vibration-reducing material is provided on the conduit-contacting surfaces of the clamps to reduce the extent of transmission of vibrations to the frame of the enclosure and to reduce wear on the main drilling fluid pressure line, typically a 4 inch (10.2 cm) X×H line. It is advantageous to reduce the vibrations in this line during high pressure pumping operations.

Another utility enclosure embodiment 100 is shown in FIG. 10. This embodiment is similar to that of utility enclosure 10 with the exception of having outer panels 124 which are hinged to the frame base members 12. One advantage of this embodiment is that the large outer panels remain closely associated with the enclosure 100 while they are open and closed. While there is a disadvantage in preventing a worker from accessing the side racks during placement of outer conduits, this disadvantage could be addressed if two workers holding a conduit at opposite ends place the conduit in the rack by accessing the front and back corners of the enclosure 100. A lifting apparatus could also be used with a forklift so workers are not involved in manual installation of the conduits.

### Alternative Configurations

As noted briefly above, the example utility enclosures are customizable using essentially the same frame and panel structures with different conduit spacer sets (having spacers with radiused cutouts dimensioned for alternative conduits) and different outer rack members. Such alternatives may be provided in essentially any desired combination while taking into account the requirements of the utilities required to service the drilling rig. In some situations, where only the largest of conduits are needed to service certain aspects of a drilling rig, there may not be a need to include outer racks at all, in which case, the lateral rack members and may be omitted from the enclosure. In other cases, where only smaller diameter conduits are being used, such as a utility enclosure dedicated to protecting smaller diameter hydraulic fluid lines, there may not be a need to include larger conduits in an inner conduit array and all the required conduits are held by racks formed by the outer rack members. In such a case, there would be no need to assemble the spacer sets. The ability to customize the configuration of the conduit arrays enhances the flexibility of the enclosure and provides significant advantages over the ad hoc construction of conventional utility enclosures in enabling convenient inspection and replacement of damaged conduits with minimal interruption to drilling operations.

While the conduits illustrated in the example embodiments are in the form of rigid pipes, it is expected that lengths of flexible conduits such as hoses can also supported by the racks of the utility enclosure.

### EQUIVALENTS AND SCOPE

The terms “one,” “a,” or “an” as used herein are intended to include “at least one” or “one or more,” unless otherwise indicated.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art to which this invention belongs.

While this invention has been particularly shown and described with references to embodiments thereof, it will be understood by those skilled in the art that various changes in form and details may be made therein without departing from the scope of the invention encompassed by the appended claims.

1. An enclosure device for protection of drilling rig service utilities, the device comprising a frame substantially covered by a plurality of removable or hinged panels to provide access to one or more racks for receiving and holding one or more arrays of conduits, the frame configured to support one or more removable and reconfigurable racks for supporting the arrays of conduits within the enclosure with ends of the conduits extending outside of the enclosure device.

2. The enclosure device of claim 1, wherein the plurality of removable or hinged panels comprises at least one hinged or removable top panel to provide access to an interior rack.

3. The enclosure device of claim 1, wherein the plurality of removable or hinged panels comprises at least one hinged or removable side panel to provide access to at least one lateral rack.

4. The enclosure device of claim 1, wherein the frame comprises a plurality of sets of inner frame members, wherein at least some of the sets inner frame members are connected to support components used to form the one or more removable and reconfigurable racks.

5. The enclosure device of claim 4, wherein the sets of inner frame members each include a pair of opposed vertical supports and wherein at least some of the support components used to form the one or more removable and reconfigurable racks includes sets of spacers connected medially between the vertical supports to form an interior rack.

6. The enclosure device of claim 5, wherein each set of spacers includes individual spacers defined by either upper or lower cut out portions matched to adjacent spacers to form openings for holding the conduits.

7. The enclosure device of claim 5, wherein each set of spacers includes individual spacers defined by lower cut out portions matched to adjacent spacers to form openings for holding the conduits, and the lower cut out portions have lower conduit clamp halves connected thereto.

8. The enclosure device of claim 7, further comprising separate upper conduit clamp halves for connecting to the lower conduit clamp halves following placement of conduits on the lower conduit clamp halves.

9. The enclosure device of claim 4, wherein at least some of the components used to form the one or more removable and reconfigurable racks include a lateral rack member connected laterally to at least some of the vertical supports.

10. The enclosure device of claim 1 comprising six sets of inner frame members, wherein two of the six sets of inner frame members are located at the ends of the enclosure device and are each provided with spacer sets which form end walls of the enclosure device.

11. The enclosure device of claim 10, wherein the vertical supports of the two sets of inner frame members located at the ends of the enclosure device have lateral rack members connected thereto.

12. The enclosure device of claim 11, wherein the lateral rack members of one side of the enclosure device are configured to support a first outer array of conduits having conduits of two different diameters and the lateral rack members of the other side of the enclosure device are configured to support a second array of conduits having conduits of the same diameter.

13. The enclosure device of claim 12, wherein the first outer array of conduits includes three conduits having an inner diameters of about 2 inches and two conduits having inner diameters of about 1.5 inches and the second outer array of conduits includes ten conduits having an inner diameter of about 1 inch.

14. The enclosure device of claim 5, wherein the sets of spacers are configured to support six conduits having inner diameters of at least 3 inches in a staggered arrangement.

15. The enclosure device of claim 14 wherein the six conduits include four conduits having an inner diameter of about 3 inches, one conduit having a diameter of about 4 inches to about 5 inches and one conduit having an inner diameter of about 6 inches to about 8 inches.

16. The enclosure device of claim 1, which has a length of about 40 feet and a width of about 3 feet, 8 inches.

17. The enclosure device of claim 1, further comprising one or more cable support trays supported by upper frame members of the frame.

18. The enclosure device of claim 1, further comprising a hitch connected to each end of the enclosure device for coupling to a towing vehicle.

19. The enclosure device of claim 1, further comprising a pair of forklift sockets formed in frame base members of the frame.

20. The enclosure device of claim 19, further comprising a pair of runners connected to the undersides of each of the frame base members.
